(19) United States
(12) Patent Application Publication
(10) Pub. No.: US 2023/0296511 A1
(43) Pub. Date: Sep. 21, 2023

(54) Multi-region optical filters and systems and methods using same

(71) Applicant: Maytronics Ltd., Kibbutz Yizrael (IL)

(72) Inventors: Hanoch KISLEV, Zichron Yaakov (IL); Shahar SOBOL, Haifa (IL); Yehonatan Evgeniy TILCHIN, Haifa (IL); Alexander RACHMAN, Holon (IL)

(21) Appl. No.: 18/042,220

(22) PCT Filed: Aug. 19, 2021
(86) PCT No.: PCT/IL2021/051019

§ 371 Date: Feb. 20, 2023

Related U.S. Application Data
(60) Provisional application No. 63/068,085, filed on Aug. 20, 2020.

(51) Int. Cl. G01N 21/51; G01N 21/31; G01N 21/64; G01J 3/42; G01J 3/02; G01J 3/28

(52) U.S. Cl. CPC G01N 21/51; G01N 21/31; G01N 21/64; G01J 3/42; G01J 3/0208; G01J 3/0213; G01J 3/0227; G01J 3/2803

(57) ABSTRACT

A liquid measuring system (LMS) comprising: a light source; a multi-region optical filter (MROF); a sample cell configured to contain a liquid sample; an optical detection subsystem (ODS) having an optical detector for measuring optical properties of light emanating from the liquid sample. The MROF may include a spectral filter region such as a bandpass or a long-pass filter type region, and natural density (ND) type filter region, for enabling simultaneous optical measuring at least of turbidity level and algae concentration in a water sample contained by the sample cell, by having light passed through the water sample and the MROF before reaching the optical detector of the ODS. Embodiments of the MROFs may be also used, for example for selective spectral attenuation of light illuminating the liquid sample to achieve reduction in distortions due to stray light.

### CROSS-REFERENCE TO RELATED APPLICATIONS

This PCT application claims priority from U.S. provisional application No. 63/068,085, filed Aug. 20, 2020, entitled “Multi-Region Optical Filter,” which is incorporated herein by reference in its entirety.

### FIELD OF THE INVENTION

The present invention relates to optical filters. More specifically, the present invention relates to optical filters having multiple regions having different optical filtering characteristics.

### BACKGROUND OF THE INVENTION

Optical filters are widely used for many purposes and in various designs. Bandpass optical filters are designed to transmit therethrough a specific wavelength range, which may have a narrow or wide bandwidth, while rejecting energies external (higher and lower in wavelength) to the specific wavelength range.

Long-pass optical filters are typically designed to transmit longer wavelengths (e.g., in the visible (VIS) and/or infrared (IR) range, and attenuate the shorter wavelengths, whereas short-pass optical filters are designed in an opposite manner, attenuating the longer wavelengths.

Natural density (ND) optical filters are often designed to attenuate a specific wavelength range (typically in the VIS range) for reducing intensity of the impinging light by reflecting or absorbing thereof, without significantly changing the relative intensity of wavelengths within the specified ND range.

### BRIEF DESCRIPTION OF THE FIGURES

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear.

The figures are listed below as follows:

FIG. 1 illustrates a liquid-properties measuring system using a multi-region optical filter located between a light source of the system and a sample cell containing a liquid-sample therein, in accordance with some embodiments;

FIGS. 2A-2C illustrate an multi-region optical filter (MROF) in accordance with some embodiments, having multiple filter regions of at least two filter types: a spectral filter region such as a bandpass (BP) filter region or a long-pass filter region or short-pass filter region and a natural density (ND) filter region type coupled to one another: FIG. 2A shows a perspective view of the MROF; FIG. 2B shows a magnified view of a part of the ND filter region including transparent and coated (e.g., reflective) areas; and FIG. 2C shows a side view of the MROF and a near-collimated beam passed therethrough.

FIGS. 3A-3C illustrate another configuration of a MROF made from a single monolithic substrate having multiple BP and ND filtering regions by having a BP coating and ND etching regions in accordance with some embodiments, wherein: FIG. 3A shows a perspective view of the MROF; FIG. 3B shows a magnified view of a part of the MROF; and FIG. 2C shows a side view of the MROF and a near-collimated beam passed therethrough;

FIG. 4A-4B schematically illustrate the differences in spectroscopy in different cases—using distilled or swimming pool water for the liquid sample: FIG. 4A shows the spectra differences especially in the deep ultraviolet (UV) range when using a simple single natural density (ND) optical filter; and FIG. 4B shows the spectra differences especially in the deep ultraviolet (UV) range when using a MROF of the present invention;

FIG. 5 shows a schematic layout of a system using a MROF located between a sample cell containing a liquid-sample therein and an optical detection subsystem, for simultaneous detection of water sample characteristics including at least turbidity level and biomass concentration and/or quantity, in accordance with some embodiments; and

FIG. 6 shows a flowchart, schematically illustrating a method for simultaneous detection of characteristics of a water sample, including at least turbidity level and biomass concentration and/or quantity, using a MROF based system, according to some embodiments.

### DETAILED DESCRIPTION OF SOME EMBODIMENTS

Spectral filters, such as for instance, a bandpass filter, are typically manufactured by a multi-layer coating. However this technology is limited, especially when an arbitrary transmission spectrum is required.

Aspects of embodiments of the present invention pertain to multi-region optical filters and methods and systems using one or more such multi-region optical filters.

According to some embodiments, there is provided a multi-region optical filter (MROF) having two or more regions, each with a different optical/filtering properties such as different transmission spectrums and/or of a different intensity reduction characteristics for measuring, for example, characteristics of a liquid sample located in a sample cell, for measuring various optical properties of the liquid sample.

The term “water sample” used herein is a specific non-limiting example of one optional type of liquid sample being measured.

Aspects of disclosed embodiments pertain to a multi-regional optical filter (MROF) that has at least two different optical filter types. The MROF different filter regions may be located adjacent (coupled) to each other and/or integrally connect to one another forming a single MROF optical element. The MROF different filter regions may be coplanar or have any desired useful shape. For example, the MROF may be shaped to also function as a lens.

Aspects of disclosed embodiments pertain to a MROF that has two or more filter-regions of two filter types: a “selection filter type” (of one or more regions of the MROF) configured for selection of a wavelength band (e.g. by use of a bandpass (BP) filter type that is designed to transmit a specific wavelength range and reject energies external to the wavelength range; and a “reduction filter type” such as a natural density (ND) filter type configured for uniform attenuation of a specific wavelength range (typically in the VIS range) e.g. by reflecting or absorbing the impinging light.

Aspects of disclosed embodiments, pertain to a system for measuring liquid-properties, herein referred to also as “liquid measuring system” (LMS), that uses at least one MROF designed specifically to the specific liquid-properties' measurements.

For LMS that are configured to be used for measuring/monitoring water related properties in large water facilities such as swimming pools, the LMS may be configured to measure/monitor properties such as one or more of: turbidity, concentration and/or quantity of biological pollutants such as cyanobacteria, algae/microalgae, which can be detected via optical measuring of fluorescence light properties (e.g., caused due to biomass excitation), concentration and/or quantity of chemicals, water hardness level (associated with turbidity level changes), etc.

According to some embodiments, the LMS may include at least:
at least one light source;
a sample cell configured for holding therein a liquid/water sample (e.g. sampled from a water facility) and for optical detection of sample properties (e.g. by being partially or fully transparent);
one or more optical elements for directing, focusing and/or collimating light emanating from the light source or from the water sample;
at least one MROF including two or more different filter-type regions; and
an optical detection subsystem (ODS), configured to detect optical properties of light emanating from the sample cell/water sample and optionally from one or more additional system locations.

According to embodiments, the MROF may be located between the light source and the sample cell AND/OR between the sample cell and an optical detection subsystem.

According to some embodiments, the general turbidity level of a water sample may be determined by measuring spectral characteristics of light emanating from the water sample by analyzing, for example output signal from one or more optical detectors such as a spectrometer or an optical imaging (e.g. pixelated) detector. The output detector data/signal may be associated with (a large angle) scattered light in the water sample. The algae concentration/quantity value may be determined based on identification and analysis of fluorescence response of phytoplankton cells such as algae cells (or any other biomass) to the incoming light, irradiating the water sample, originating from a light source of a distinctive narrow wavelength (WL) range, for example in the UV-VIS WL range (e.g. between 300-450 nanometers (nm)). In certain embodiments, the light source may be configured to emit light of a distinctive WL peak (e.g. within the range of 400-450 nm e.g. 420 nm).

According to some embodiments, the LMS may include an additional optical filter such as a bandpass optical filter for narrowing the original wavelength bandwidth of the light source.

In some embodiments, the optical sensor(s) may comprise: a pixelated optical detector for example: sensor array such as a charged couple device (CCD), an active pixelated sensor such as a pixelated sensor including an array of complementary metal-oxide semiconductor (CMOS) array, or a photodiode array. The optical sensor's pixel size/area may range from 1 to 10,000 square microns. In preferred embodiments, the pixel area may range between 100 and 1000 square microns.

According to some embodiments, the general turbidity level of the water sample, may be determined by measuring optical properties of the water sample such as scattered light spectrum and/or intensity(ies). The algae concentration/quantity value may be acquired by the detection of the fluorescence response of the algae cells (or any other biomass) to the incoming light, which causes irradiation of the water sample in fluorescence light. To cause fluorescence of the biomass in the water sample, the light source, being used to illuminate the water sample may be of a distinctive narrow wavelength (WL) range, for example in the UV-VIS WL range (e.g. between 300-450 nanometers (nm)). In certain embodiments, the light source is configured to emit light of an even more distinctive WL peak (e.g. within the range of 400-450 nm e.g. 420 nm).

In some embodiments, the long/band pass filter's center wavelength (CWL), the wavelength at the center of the filter's transition from opaque to transparent, is similar/equal to or shorter than a WL range of algae/biomass fluorescence. For example, the CWL can range between 500 and 600 nm for typical algae type(s) in water facilities such as swimming pools.

In some embodiments, a focusing optics may be used before the optical detector(s) of the ODS, for narrowing incidence angle and focusing rays over the long pass filter region of the MROF. In preferred embodiments, the incidence angle ranges between 5 and 20 degrees from zero incidence angle (perpendicular to the filter's surface).

In certain embodiments, the light source may be a LED (such as a high or lower power LED) with a peak emission wavelength range of between 350 and 450 nm. In certain embodiments, the LED light emission power ranges between 10 mW and 3000 mW.

In some embodiments, the LED FWHM emission angle range between 10 degrees and 120 degrees. In other embodiments the focusing optics focuses a significant fraction of the fluorescence emission on a small area on the multi-elements filter, as to enhance the local flux on a region of the multi-element filter. In other embodiments, the said small area ranges between 0.5 and 5 square mm.

The large angle scattered light (at the light source center wavelength) intensity and/or power density may be much higher than the intensity/power density of the fluorescence light. In certain embodiments it is desired that near equal light flux is incident on the scattering pixels and the fluorescence pixels. Therefore, one or more filter regions of the MROF are designated for attenuation of flux/intensity of scattered light. In certain cases, the ratio between the scattering regions transmission and the long pass transmission (at the full transmission wavelength) can range between 1:10 to 1:1000.

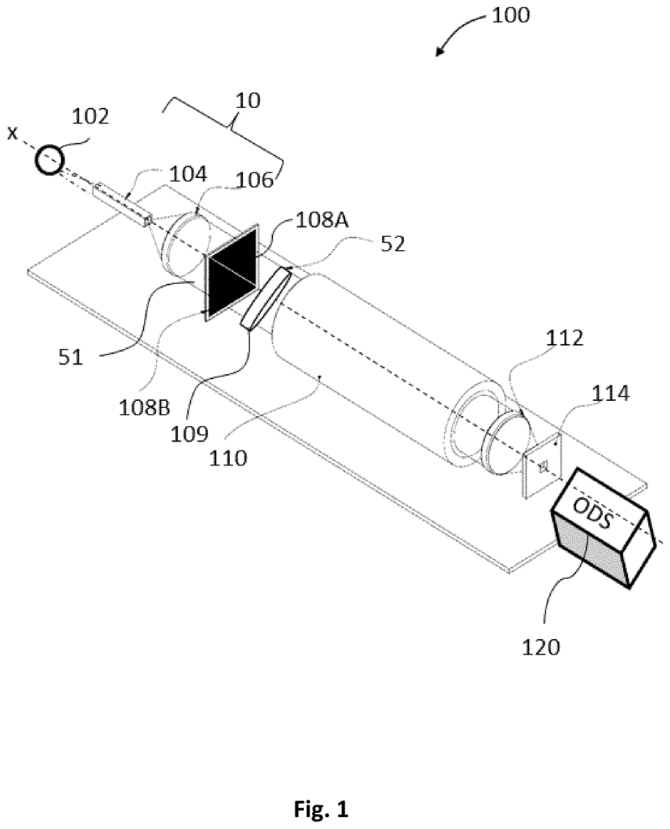

FIG. 1 schematically illustrates liquid measuring system” (LMS), 100 for measuring water characteristics, using a MROF 108 for enhancing UV illumination of a water sample, in accordance with some embodiments.

The LMS 100 may include at least:
a light source 102, such as at least one light emitting diode (LED) or Xenon (Xe) lamp, which may emit light in the broadband, the violet or ultraviolet (UV) wavelength ranges such as between 400-450 nm (violet) or 200-350 (UV);
a first optical setup 10 for manipulating and/or directing the light outputted from the light source 102 to form for example, a collimated or near collimated beam 51, the first optical setup may include for example, a first mixing component 104 and a collimating lens 106;
a sample cell 110 configured to hold therein a water sample for optical detection of the water characteristics;
an optical detection subsystem (ODS) 120 for detecting optical characteristics (such as spectral characteristics such as absorption characteristics) of light emanating from the sample cell 110;
a multi-region optical filter (MROF) 108, positioned between the light source and the sample cell 110, the MROF 108 being configured at least to reduce light in spectral areas where the light source is too powerful (for example in near UV-VIS range) and increase relative intensity of light in spectral areas where the light source is weak (for example deep UV) in the light flux impinging over the water sample in the sample cell 110, to achieve maximal flux that can be measured in the previously weak spectral areas while still preventing detectors' saturation, where the filtered beam 52, exiting the MROF 108, may be near collimated, spectrally improved so as to reduce the adverse impacts of stray light that will be generated in the ODS, the filtered beam 52 may be then directed into the sample cell 110;
means for focusing a significant fraction of the light beam exiting the sample cell 110 such as a focusing lens 112, e.g. for focusing the light beam onto a small aperture 114 for entering the optical detection subsystem 120.

According to some embodiments, the ODS 120 may include a spectrometer or any other optical detector such as a pixelated optical detector (e.g. including an array of optical sensors each optical sensor in the sensor array may be configured to generate an output signal that can be translated into (readable) sensor data).

In accordance with some embodiments, the light source 102 may be coupled to the first mixing component 104. The light beam exiting the first mixing component 104 may propagate to the collimating lens 106 to produce a collimated or near-collimated beam 51.

The collimated or near-collimated beam 51 passes through a MROF 108 and then through a sample cell 110 filled with sample water, e.g., sampled from a swimming pool.

The light exiting from the sample cell 110, may be collected by a focusing lens 112 and directed towards the aperture 114.

In accordance with some embodiments, the MROF 108 is positioned between the light source 102 and the aperture 114 of the spectrometer to reduce spectrometer stray light while measuring water quality.

In accordance with some embodiments, the optical multi-region filter 108 is a filter comprised of a bandpass-like filter 108A and a ND filter 108B.

In accordance with some embodiments of the present invention, the LMS 100 enables the use of a standard and relatively cheap light source 102. Such light source 102 may include at least one pulsed Xe (Xenon) lamp which can be very strong in emitting in the blue wavelengths range and is less powerful in other wavelengths such as deep UV wavelengths.

According to some embodiments, the MROF 108 modifies the spectrum of the light source 102 by enhancing the deep UV spectral portion with respect to the near UV and blue portion.

For instance, part of the light beam passes through a filter region 108A which includes a deep UV bandpass (BP) filter (herein BP filter region 108A), and another part of the light beam passes through a natural density (ND) filter region 108B which acts like as an ND filter. This configuration, enhances the UV relative content of the beam exiting the filter and propagating towards a pool water filled sample cell 110.

In accordance with some embodiments of the present invention, the light source 102 may comprise Xenon lamp and may be configured to generate multiple wavelengths, broadband, or polychromatic light. The light can be circularly polarized, linearly polarized, elliptically polarized, non-polarized, or selectively polarizable.

The light source 102 may include one or more filament lamps, discharge lamps, or super luminescent diodes. The produced light may be selected from a group comprising coherent, semi-coherent, or incoherent light.

In accordance with some embodiments of the present invention, the means for collecting and directing a significant fraction of the light produced via the light source 102, the means for near collimating the mixed light beam exiting the first mixing component 104 to near collimated beam, and the means for focusing a significant fraction of the light beam exiting the sample cell 110 onto the small aperture 114 may comprise lens(es), light wave guide(s), mirror(s), a combination thereof, or other focusing means.

The sample cell 110 may be a transparent or semi-transparent liquid container e.g. comprising transparent windows for said beam injection and passing beam collection.

The focusing lens 112 may be used for coupling at least a portion of the light emanating from the sample cell 110, into a small-sized aperture 114 at the entrance to the spectrometer. The aperture 114 enables proper operation of the ODS 120. More specifically, the aperture 114 assists the spectrometer in generating a signal representing the spectrum of the incoming light.

Typically, the light which enters through the aperture is projected by the spectrometer optics onto a spectral resolving sensor array which converts the incoming light spectrum (e.g., UV & VIS window) into electronic signal.

In accordance with some embodiments of the present invention, the multi-region filter 108 of the present invention includes a pair of filtering regions namely (i) a band pass-like filter 108A for enhanced transmission of deep UV portion therethrough, and (ii) an ND filter 108B for transmitting mid VIS portion therethrough.

The spectrally modified light exiting the MROF 108 passes through the pool water filled sample cell 110, exits the pool water filled sample cell 110 and is focused into an aperture 114. The changes in spectrum of light passing the aperture can be used to monitor the presence, absence, or absolute or relative concentration of analyte(s), or a change in concentration due to diffusion or flow.

In accordance with some embodiments of the present invention, the BP filter region 108A may include a stack of thin film layers including multiple different materials, e.g., high-index, low index, and/or absorbing layers.

The BP filter region 108A may be configured for transmission of light in a specific predefined spectral band. The ND filter region 108B is configured for reducing relative intensity of potentially stray light (of specific WLs). Thus, MROF 108 improves enhancement of deep UV rays' transmission over the VIS spectral window.

According to some embodiments, the LMS 100 may further include a second mixing component 109 located anywhere between the MROF 108 and the ODS 120, such as, for example, between the MROF 108 and the sample cell 110 as illustrated in FIG. 1 or between the sample cell 110 and the ODS 120, configured and positioned for spectral spatial distribution unification of light emanating/exiting the MROF 108.

Since the light exiting the MROF 108 is spatially divides into two areas each having different spectral characteristics, the second mixing component 109 may allow unifying spatial distribution of the light beam spectrum, before entering the spectrometer of the ODS 120, thereby improving the spectrometer's absorption spectrum detection.

According to some embodiments, as shown in FIG. 1, the components of the LMS 100 are all optically aligned about a single optical axis x such that the surface plane of the MROF 108 is parallel to the surface of the aperture 114 and an input surface plane of the ODS 120, all surfaces perpendicular to the optical axis x.

According to some embodiments, the aperture 114 may be an element including an aperture-frame and a solid foil held within the aperture-frame.

According to some embodiments, the MROF may be segmented, having multiple segments of alternating filter region types for enabling, for example, combined regional filtering and beam mixing. For example, the MROF may have alternating segments of a first filter type (e.g., ND or bandpass type) and a second filter region type (such as bandpass filter type of a different wavelength range). The segmented MROF may be located between the light source 102 and the sample cell 110 using the LMS 100 main design as shown in FIG. 1, without requiring the use of the second mixing component 109 and optionally also without requiring using the first mixing component 104.

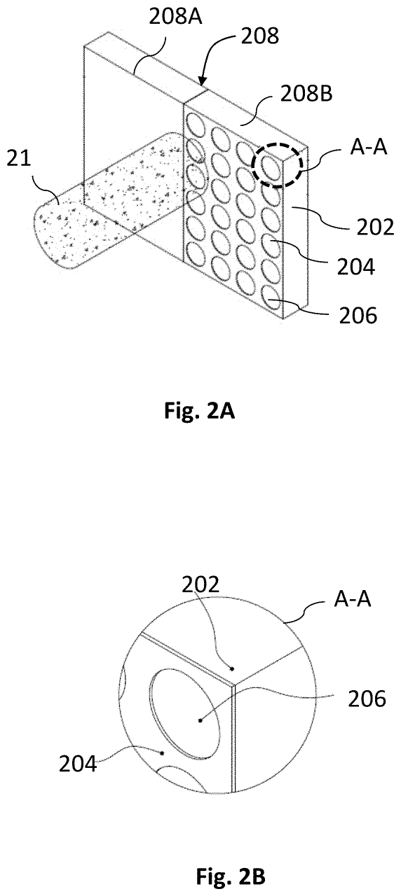

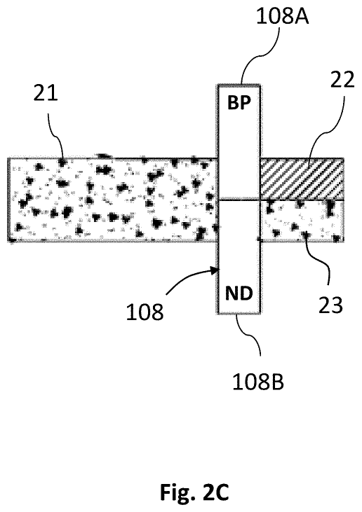

FIGS. 2A-2C show a MROF 108, according to some embodiments.

FIGS. 2A and 2B show a MROF 208, according to some embodiments. The MROF 208 includes a first BP filter region 208A and a second ND filter region 208B. The ND filter region 208B may include a light blocking or absorbing background region 204 and multiple transparent regions 206.

Here the ND filter region 208B may be manufactured by coating the silica substrate 202 with a light blocking (absorbing or reflective) layer. The uncoated transparent regions 206 may be generated by evaporation, etching etc., of the coating, or by masking the silica substrate 202 with a protective pattern prior to coating the substrate 202 and then removing the mask. The transparent regions 206 may be similar in material and optical properties to the silica substrate 202 when uncoated, such as, for example, to enable transmission of a wide spectral range therethrough. The grid background layer 204 may be reflective made of materials which withstand prolonged deep UV radiation e.g., by reflecting some of the impinging rays and may also be used for ND-based stray light flux reduction.

Preferably, the ratio between the cumulative uncoated regions 206 overall surface area St and the coated area 204 overall surface area Sb: St/(Sb+St), determines the light attenuation of this ND filter region 108B (uncoated area(s))

As seen in FIG. 2C, when a collimated entering light beam 21 passes through MROF 108, the BP filter region 108A mainly transmits the short UV portion 22 of the near-collimated beam 21, while the ND filter region 208B does not filter a spectral band but attenuates and intensity reduces all light in the entering light beam 21 generating an attenuated exiting beam portion 23. When the beams recombine, the resulting spectrum has a much more pronounced short UV content which. When measured in a spectrometer, is much less prone to the effect of stray light generated from the other parts of the spectrum.

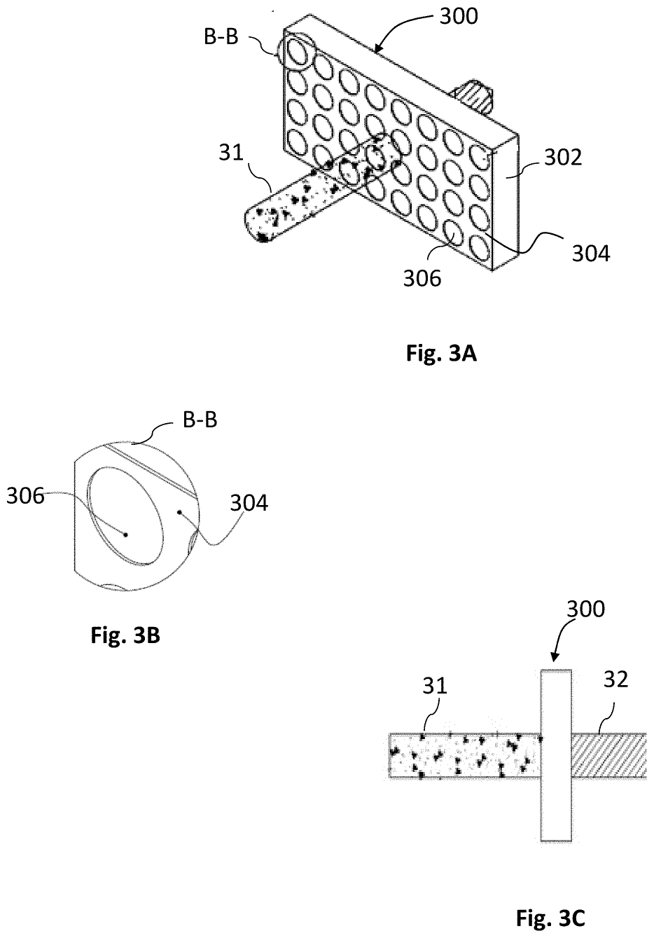

FIGS. 3A-3C illustrate a MROF 300 in accordance with some embodiments of the present invention.

The MROF 300 may include multiple spectral filter regions of various filtering types such as various bandpass, (BP) long pass (LP) and/or ND filter regions types and multiple ND filter regions positioned intermittently in respect to one another such as in a grid form.

For example, as shown in FIGS. 3A-3B, an optical substrate 302 may be coated with a BP coating layer where ND regions 306 can be generated by masking, etching, imprinting, evaporating, etc. the coating layer in specific patterned regions forming the ND regions 306. For example, as shown in FIG. 3A, MROF 300 may include a single optical substrate 302 coated with a deep UV bandpass coating 304 with multiple circular shaped etched regions 306 which are relatively transparent to the beam 31.

The deep UV bandpass coating 304 reduces intensity of specific one or more WL ranges (e.g., in the VIS and long wavelength ranges) while multiple circular shaped etched ND filter regions 306 may be transparent to the full light source spectrum (including the deep UV spectral band) but reduce its intensity.

The ratio between the cumulative openings 306 area and the coating layer 304 such as the ratio between deep UV and UV+VIS intensities may be used to calculate absorption characteristics of the water sample.

In accordance with the present invention, the patterns shown in FIGS. 2A-2B and 3A-3C are for illustration only. Multiple other patterns may be applicable and may be set by the filter designer. More specifically, the specific patterns as well as the ratio between the cumulative uncoated regions area and the coated area are variable.

Preferably, the multi-region substrate 302 material may be fused silica, UV grade silica sapphire or CaF2.

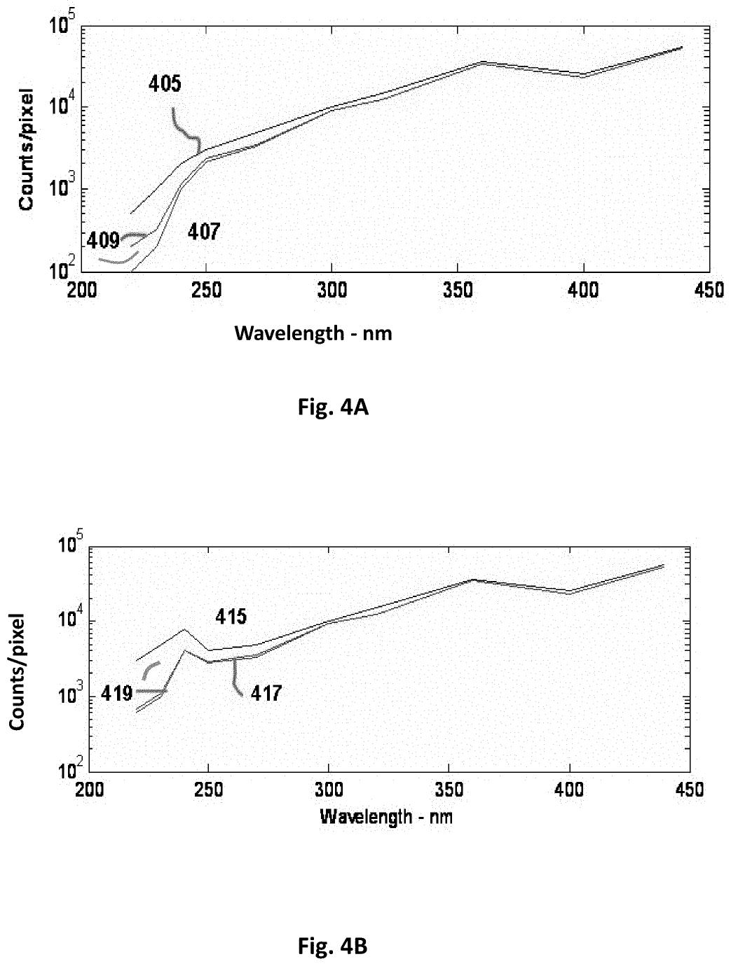

FIGS. 4A and 4B illustrate the advantages of using the MROF 108 for improving accuracy in deep UV spectroscopy measurements. FIG. 4A shows the spectrometer acquired spectra (in a logarithmic coordinate) from a Xe lamp, after passage through an ordinary ND filter and a water-filled LMS 100. The distilled water acquired spectrum 405, is characterized with intense spectral peaks in the violet and near UV region and a low spectral power in the deep UV.

A modified spectrum 409 is obtained when the distilled water in the sample cell 110 is replaced with pool water. Spectrum 409 shows violet and near-UV peaks but a low deep-UV section. The pool-water theoretical spectrum 407 (without stray light contribution) shows a highly attenuated deep-UV section.

The difference from measured spectrum 409 and theoretical spectrum 407 results from a significant stray light contribution. The stray light spectrally diffuses within the spectrometer from the violet and near-UV pixels to the weakly illuminated deep UV pixels. The stray light contribution is unpredictable and modifies the deep-UV section of spectrum 409 vs. theoretical spectrum 407. As a result, such stray light level reduces accuracy of pool water spectroscopy in the deep-UV region.

FIG. 4B shows the spectra, after passage through the MROF and the sample cell 110, when filled with distilled or swimming pool water. The distilled-water acquired spectrum 415 shows violet & near UV peaks similar to those of spectrum 405. This is enabled by the beam passage through the ND region 108B of MROF 108A. In contrast, the deep-UV section, is strongly enhanced, due to the beam passage through the bandpass region 108A of MROF 108.

The pool water theoretical spectrum 417, calculated with a MROF, shows the same violet and near-UV peaks while the deep-UV section is enhanced per the respective section in spectrum 415. The pool water measured spectrum (including stray light contribution) 419, is almost similar to the theoretical spectrum 417 as demonstrated above. In turn, the MROF of the present invention virtually eliminates the induced stray light effect and enables an accurate pool water spectroscopy.

Aspects of disclosed embodiments pertain to MROFs, MROF-based systems and methods that enable simultaneous measuring of several water characteristics including for example, at least turbidity level and biomass (e.g. algae) concentration and/or quantity of biomass in sampled water.

One or more MROFs may be used in these systems, at least for the purpose of filtering light, exiting/emanating from a water sample (e.g., after being scattered/excited generating scattered and fluorescence light), where each region of the exiting light is filtered in a different manner, to enable simultaneous measuring of all (e.g. at least two) areas of the exiting light each area (at least two), for simultaneous measuring of two or more different properties of the water sample such as turbidity and algae concentration.

For example, using a MROF similar to MROF 108 having at least two parts, one part filtered via the BP region for measuring algae concentration (by transmitting a spectral wavelength band associated with fluorescence light caused due to biomass excitation and filtering out other parts of the spectrum associated with scattered light), and the other part of the MROF being configured to include a ND (or a BP transmitting mainly the excitation light WL range) filter region for measuring turbidity level. To allow such turbidity and biomass concentration simultaneous measurement, the system may be configured such that the MROF must be located between the water sample (sample cell) and the optical detection subsystem for transmitting fluorescence light emanating from the water sample via the spectral/BP filter region and for transmitting scattered light emanating from the water sample via the other filter region.

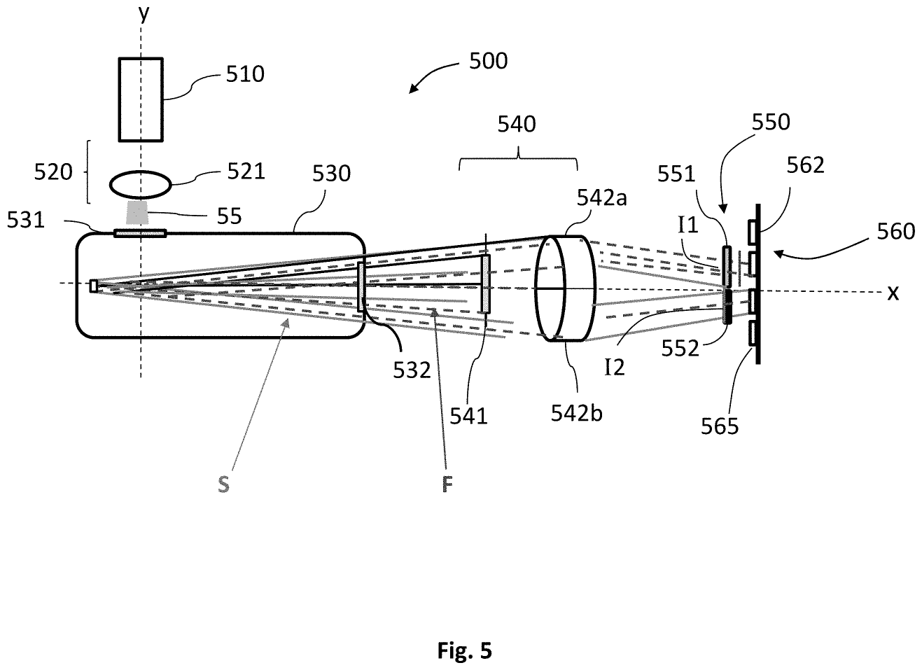

Reference is now made to FIG. 5, schematically illustrating a liquid measuring system (LMS) 500, using a MROF 550 that is configured and positioned to enable simultaneous measuring of water turbidity level and algae concentration, according to some embodiments, for significantly improving the ability to measure weak spectral emission from a water sample and for distinguishing between the scattered and fluorescence components of this light.

According to these embodiments, the LMS 500 may include at least:
a light source 510 (such as a UV, VIS or UV and VIS LED or Xe lamp(s));
a first optical setup 520 e.g. including a collimator 521 for directing and collimating light emanating from the light source 510;
a sample cell 530 such as a cuvette, a transparent or semitransparent container etc, having at least two transparent windows 531 and 532 one window 531 located such as to receive therethrough light from the light source 510 and another window located near-perpendicularly to one another, such as to allow light from the water sample to exit the sample cell 530 and be directed towards the detection subsystem;
an optical detection subsystem ODS 560;
(optionally) a second optical setup 540 for directing and/or focusing parts of light exiting the sample cell 530 towards an optical measuring subsystem, the second optical setup 540 may include, for example:
(i) an obstruction element 541 positioned and configured to block a portion of the light exiting from the sample cell 530 propagating towards the ODS 560; and
(ii) a combined-lens-array 542 such as a multifocal or a multi-image lens including for example two focusing lenses parts a first focusing lens part 542a and a second focusing lens part 542b coupled to one another, each having the same focal length (FL);
a MROF 550, located after the second optical setup 540, the MROF 550 being positioned and configured to filter each part of the light beam passed therethrough in a different manner such that at least: one part of the light beam is filtered via at least one spectral (e.g., bandpass or long-pass) filter region 551 such as long-pass filter region, for attenuating scattered light and transmitting only a specific wavelength band such as in the VIS and/or UV bands, to allow detection of fluorescence light emanating from biomass (algae) pollutants in the water sample e.g., for algae/microalgae concentration detection, and an ND or BP (configured to pass virtually only the excitation wavelength(s)) filter region 552 for turbidity level detection, and
an optical detection subsystem (ODS) 560 including for example an aperture element 565 including one or more apertures and a pixelated optical detector 562 such as a CCD sensor, a photodiode array, a spectrometer, etc., enabling spatial distinction between parts of the light beam exiting the MROF 550.

In this LMS 500 configuration, the light source 510 is positioned such that light is emitted therefrom mostly along a first axis y that is perpendicular to the surface of the first input window 531 of the sample cell 530 and light irradiated from the liquid sample (such as scattered and fluorescence light) exits through an output window 532 of the sample cell 530 that is perpendicular to a second axis x and to the first input window 531. This means that the ODS 560 aperture element 565 as well as an input surface of the pixelated optical detector 562 are positioned perpendicularly to the optical axis x, and all optical elements 541, 542 and MROF 550 are aligned with the optical axis x.

According to some embodiments, as illustrated in FIG. 5, the first focusing part 542a of the combined-lens-array 540 may be configured and positioned to form a first image I1 over the spectral filter region 551 of the MROF 550, forming a filtered image over one area of the pixelated optical detector 562; and the second focusing part 542b of the combined-lens-array 540 may be configured and positioned to form a second image I2 over the ND filter region 552 of the MROF 550 forming a second filtered image over another area of the pixelated optical detector 562. The filtered images may be directed to enter an input surface area of the pixelated optical detector 562 via specific apertures of the aperture element 565.

The spectral filter region 551 may refer to bandpass that is limited from both sides (defining a specific wavelength (WL) range of light transmission and filtering out WLs that are not within the WL range or a long-pass filter region for fluorescence light.

In some embodiments, the obstruction element 541 may be positioned and designed to narrow incidence angles range for the part of the light passed therethrough directed towards the spectral filter region 551 of the MROF 550. The spectral filter region 551 may be configured to be within the incidence angle range. In preferred embodiments, the incidence angle can range between 5-20 degrees from zero incidence along the main axis x (perpendicular to the MROFs surface).

In some embodiments, the light source 510 may be a power LED with a peak emission WL that ranges between 350 and 450 nm. The LED light source may be a power-controlled light source 510 with emission power ranging, for example, between 10 mW and 3000 mW. In some embodiments, the LED emission angle may range between 10 degrees and 120 degrees.

The second optical setup 540 may be arranged for focusing of a significant fraction of the fluorescence emission from the water sample, over a very small area on the MROF 550, to enhance the local flux on spectral filter region 551 of the MROF 550. In some embodiments, the said small area ranges between 0.5 and 5 square mm.

The large angle scattered light (at the light source center wavelength) may be of substantially higher intensity than the intensity of fluorescence intensity. In certain embodiments it may be desired that near equal light flux is incident on the scattering pixels (area(s) in the pixelated optical detector for detection/measuring of turbidity level) and the fluorescence pixels (area(s) in the pixelated optical detector for detection/measuring of algae concentration). This may require attenuation of scattered light of the incoming light flux. In certain cases, the ratio between the scattering regions transmission and the band/long pass transmission (at the full transmission wavelength) can range between 1:10 to 1:1000. The regions 551/552 of the MROF 550, are each designated for measuring of a different light type/spectrum (scattered or fluorescence).

It is noted that the term “partially illuminated” may refer, for example, to an array of adjacent pixels (herein also “pixels cluster”) that only a fraction of their surface is illuminated by the incoming light flux (large angle scattered or fluorescence).

In certain embodiments, the aperture element 565 may include a single perforated foil having openings that form the apertures, where the film may be located at close proximity or coupled to an input surface of the pixelated optical detector 562.

The apertures dimensions, size and shape, may be designed for minimizing the fraction of partially illuminated pixels. In other embodiments, the MROF 550 may be configured for apertures surface which is placed at close proximity to the pixelated optical detector 562. For example the aperture element 565 may be ink-printed on one of the surfaces of MROF 550 filter regions 551 and 552.

The LMS 500 may further include one or more processing units, device, machines and/or subsystems configured for receiving and analyzing output data arriving from the ODS 520 and optionally from other LMSs, for determining characteristics of the water sample and optionally also properties and/or impairments of the LMS 500. The processing unit may be associated with one or more input devices for receiving user and input and with one or more output devices for outputting processing results.

According to some embodiments, the ODS 560 may include or be communicatively and/or operatively associated with one or more computer-based devices or systems for any one or more of:
(i) receiving and processing of output data from the ODS 560 for determining one or more of the liquid sample properties such as the turbidity level, the algae concentration/quantity, other liquid properties such as hardness level, chemical pollutants concentration and/or type, etc.;
(ii) identification of alerting situations such as dangerous turbidity level and/or pollutants (biological or chemical) concentration, etc.
(ii) displaying or sending information indicative of identified alerting situations and/or information indicative of the measured properties;
(iv) determining of one or more maintenance actions to be automatically or manually performed to a water facility (such as a swimming pool) from which the liquid sample is taken.

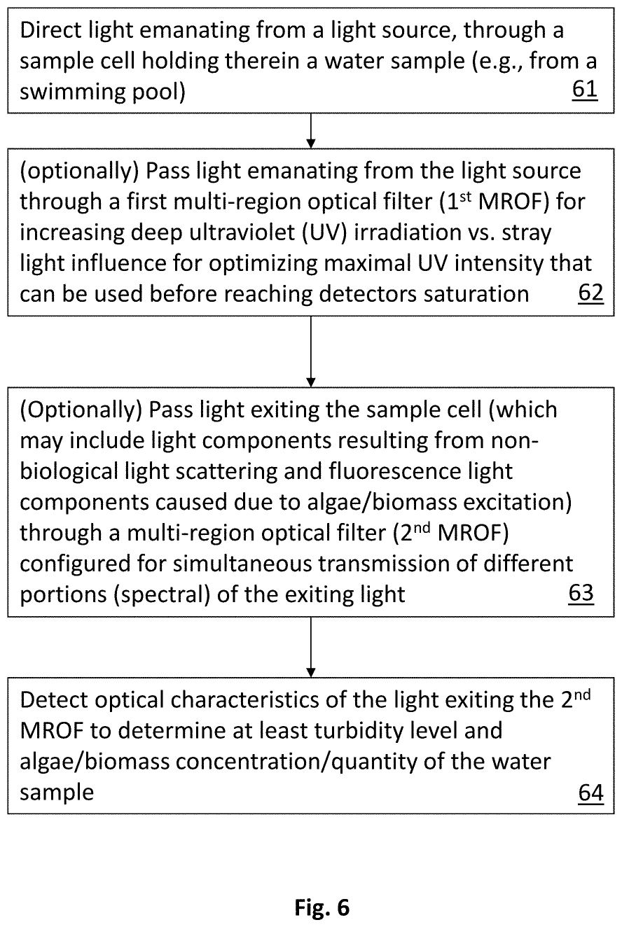

Reference is now made to FIG. 6 schematically illustrating a method for simultaneous measuring of turbidity level and biomass concentration in a water sample, held in a sample cell, according to embodiments. The method including for example, at least some of the steps of:
directing light emanating from a light source, through a sample cell holding therein a water sample (e.g., from a swimming pool) 61;
(optionally) passing/directing light emanating from the light source through a first multi-region optical filter (1^{st} MROF) for increasing deep ultraviolet (UV) irradiation vs. stray light influence for optimizing maximal UV intensity that can be used before reaching detectors saturation 62;
(optionally) passing/directing light exiting from a sample cell containing a water sample therein (where the exiting light may include light components resulting from biological and/or non-biological light scattering and fluorescence light components caused due to algae/biomass excitation) through a multi-region optical filter (2^{nd} MROF) configured for simultaneous transmission of different portions (spectral) of the exiting light 63, The 2^{nd} MROF having for example at least one spectral filter region and at least one ND filter region;
detecting optical characteristics of the light exiting the 2^{nd} MROF to simultaneously determine at least turbidity level and algae/biomass concentration of the water sample 64, using an optical detection subsystem that may include a pixelated optical detector, e.g., by associating an area of the pixelated optical detector with a different filter region and using an area of the pixelated optical detector that is associated with the spectral filter region(s) to detect biomass concentration and area(a) associated with the ND filter region(s) to detect scattered light and determine turbidity level of the water sample based on scattered light characteristics.

In some embodiments, the band pass filter region wavelength, fits the typical range of algae/biomass fluorescence, such as between 500 and 700 nm. In other embodiments, the long pass filter will be configured such that its transmission range includes the typical wavelength range of algae/biomass but excludes the excitation wavelength range.

In some embodiments, the spectral optical sensor's focusing optics is designed with a stop which narrows the focused rays' incidence angle range on the long pass filter. The long pass filter exhibits the desired long-pass transmission spectrum at a certain incidence angle. In preferred embodiments, the incidence angle ranges between 5 and 20 degrees from zero incidence (perpendicular to the filter's surface). The combination of the multi-imaging lens, said stop and long-pass filter ensures proper long-pass filtering of the incoming beam.

The scattered light S components of the light emanating from the liquid sample in the sample cell 530 are indicated in blue, where the fluorescence light components F are indicated in red dashed lines. For example, when using a light source that illuminates the water sample at 420 nm WL peak, the scattered light peak may be of 420 nm (same as illumination WL peak), and the fluorescence light of algae may range between 550-720 nm typically peaking at 680 nm.

In certain embodiments, the light source is a light emitting diode (LED) outputting light of a spectral peak wavelength that can range between 350 and 450 nm. In certain embodiments, the LED light emission power ranges between 10 mW and 3000 mW.

Additionally or alternatively, the LED full-width half maximum (FWHM) beam angle ranges between 10 degrees and 120 degrees.

Additionally or alternatively, the focusing optics, focusing a significant fraction of the light exiting the sample cell, onto a small area on the MROF, as to enhance the local flux on the spectral filter region(s) of MROF, ranging for example between 0.5-5 square mm.

### EXAMPLES

Example 1 is a liquid measuring system (LMS) comprising:
(i) at least one light source;
(ii) at least one multi-region optical filter (MROF) comprising: at least one first filter region configured for a first type of optical filtering; and at least one second filter region, configured for a second type of optical filtering, different than the first type of optical filtering, wherein the MROF is designed such that its filter regions are located adjacent to one another in a manner that enables simultaneous different filtering of different spatial parts of incoming light beam;
(iii) a sample cell configured to contain a liquid sample therein, the sample cell being partially or fully transparent to allow light from the at least one light source to enter therein and light to exit therethrough; and
(iv) an optical detection subsystem (ODS), comprising at least one optical detector for measuring optical properties of light emanating from the liquid sample, for measuring one or more characteristics of the liquid sample.

In example 2, the subject matter of example 1 may include, wherein the at least one first filter region comprises a bandpass or a long-pass filter region configured for transmission of light of a specific wavelength range or that exceed a specific wavelength threshold, and the at least one second filter region comprises a natural density (ND) filter region or a bandpass filter region.

In example 3, the subject matter of any one or more of examples 1 to 2 may include, wherein the at least one MROF is located between the sample cell and the ODS for enabling simultaneous measuring of turbidity level and biomass concentration.

In example 4, the subject matter of example 3 may include, wherein the LMS further comprises an optical subsystem configured and positioned for:
(i) directing at least one part of light emanating from the sample cell towards the at least one first filter region of the MROF, for measuring biomass concentration by measuring properties of fluorescence light irradiated from the liquid sample in the sample cell; and
(ii) directing at least one other part of light emanating from the sample cell towards the at least one second filter region of the MROF, for measuring turbidity level by measuring properties of scattered light irradiated from the liquid sample in the sample cell, thereby enabling simultaneous measuring of turbidity and biomass properties of the liquid sample.

In example 5, the subject matter of example 4 may include, wherein the optical subsystem comprises a combined-lens-array configured and positioned to form multiple images over the different MROF filter regions.

In example 6, the subject matter of any one or more of examples 3 to 5 may include, wherein the LMS further comprises:
(i) a first optical setup configured and positioned for directing light emanating from the light source towards the sample cell; and/or
(ii) a second optical setup for directing light exiting the sample cell towards the MROF.

In example 7, the subject matter of example 6 may include, wherein the second optical setup comprises: (i) an obstruction element positioned and configured to block a portion of the light exiting from the sample cell at a specific area around the main optical axis x; and (ii) a combined-lens-array comprising at least two focusing lenses parts a first focusing lens part and a second focusing lens part coupled to one another, for focusing at least one part of the light emanating from the sample cell towards the at least one spectral filter region of the MROF, and focusing at least one other part of the exiting light towards the at least one other spectral filter region of the MROF.

In example 8, the subject matter of any one or more of examples 3 to 7 may include, wherein the at least one optical detector of the ODS comprises a spectrometer and/or a pixelated optical detector.

In example 9, the subject matter of example 7 may include, wherein the pixelated optical detector comprises one of: at least one pixelated charged coupled device (CCD), an active pixelated sensor, an array of photodiodes, an array of photodetectors.

In example 10, the subject matter of any one or more of examples 8 to 9 may include, wherein the ODS further comprises one or more aperture elements located in proximity to an input surface of the at least one optical detector.

In example 11, the subject matter of any one or more of examples 3 to 10 may include, wherein the biomass comprises one or more types of: algae, microalgae or any other biological substance that can generate responsive fluorescence radiation.

In example 12, the subject matter of any one or more of examples 1 to 2 may include, wherein the MROF is located between the at least one light source and the sample cell, for selective spectral attenuation of the light emanating from the at least one light sources for improved measurement of the absorption spectrum of the liquid sample.

In example 13, the subject matter of example 12 may include, wherein the LMS further comprises a mixing component located between the light source and the MROF.

In example 14, the subject matter of any one or more of examples 12 to 13 may include, wherein the LMS further comprises a second mixing component, located between the MROF and the ODS or preferably between the MROF and the sample cell, for spectral spatial distribution unification.

In example 15, the subject matter of any one or more of examples 12 to 14 may include, wherein the LMS further comprises at least one optical element configured and located to direct, collect and/or collimate light emanating from the sample cell to the ODS.

In example 16, the subject matter of any one or more of examples 12 to 15 may include, wherein one region of the MROF comprises a transparent silica substrate having separated regions thereof coated with a light absorbing, reflective or blocking coating material, for selective reduction of light from some spectral regions that may later stray in the ODS and adversely impact the measurement accuracy in other spectral regions.

In example 17, the subject matter of any one or more of examples 1 to 16 may include, wherein the MROF is segmented, having multiple segments of alternating filter region types.

In example 18, the subject matter of any one or more of examples 1 to 17 may include, wherein the at least one light source comprises at least one Xenon lamp or at least one light emitting diode (LED).

In example 19, the subject matter of any one or more of examples 1 to 18 may include, wherein the at least one light source is configured to output light within a wavelength spectral range having a wavelength peak of between 300-450 nanometer (nm), and/or having output power of between 10-3000 mW (microwatt).

In example 20, the subject matter of example 1 may include, wherein the LMS comprises at least two MROFs at least one MROF being located between the at least one light source and the sample cell configured for selective spectral attenuation of incoming light and at least one additional MROF located between the sample cell and the ODS configured for simultaneous spectral measuring of scattered and fluorescence light emanating from the liquid sample at least for simultaneous turbidity level and biomass concentration measuring.

Example 21 is a method for simultaneous measuring of turbidity level and biomass concentration in a water sample, held in a sample cell, the method comprising, at least:
directing light emanating from at least one light source, through a sample cell holding therein a water sample;
directing light exiting from the sample through a multi-region optical filter (MROF) configured for simultaneous transmission of different portions of the exiting light, wherein the MROF comprises at least two filter regions of different filtering properties; and
detecting optical characteristics of the light exiting the MROF, using an optical detection subsystem, to simultaneously, measure at least turbidity level and biomass concentration.

In example 22, the subject matter of example 21 may include, wherein the turbidity level is measured by detection of spectral properties of scattered light components transmitted via at least one of the at least two filter regions of the MROF, and the biomass concentration of quantity is measured by detection of properties of fluorescence light components transmitted via at least one other filter region of the MROF.

In example 23, the subject matter of any one or more of examples 21 to 22 may include, wherein at least one of the filter regions of the MROF comprises at least one natural density (ND) or at least one bandpass filter configured for improving scattered light measurements and at least one other filter region of the MROF comprises a bandpass or long-pass filter configured for improving fluorescence light measurements.

Example 24 is a method for reduction of stray light emanating from at least one light source, the method comprising, at least:
directing light exiting from the at least one light source through a multi-region optical filter (MROF) configured for simultaneous transmission of different portions of the exiting light, wherein the MROF comprises at least two filter regions having different optical filtering properties;
directing light from the MROF towards a sample cell containing therein a liquid sample; and
measuring optical properties of light emanating from the liquid sample to detect one or more characteristics of the liquid sample.
wherein at least one of the filter regions of the MROF is configured for selective spectral attenuation of incoming light.

In example 25, the subject matter of example 24 may include, wherein at least one of the filter regions of the MROF comprises at least one natural density (ND) filter and/or at least one bandpass filter.

Although the above description discloses a limited number of exemplary embodiments of the invention, these embodiments should not apply any limitation to the scope of the invention, but rather be considered as exemplifications of some of the manners in which the invention can be implemented.

The system, module, unit, device etc. or parts thereof, may be programmed to perform particular functions pursuant to computer readable and executable instructions, rules, conditions etc. from programmable hardware and/or software based execution modules that may implement one or more methods or processes disclosed herein, and therefore can, in effect, be considered as disclosing a “special purpose computer” particular to embodiments of each disclosed method/process.

Additionally or alternatively, the methods and/or processes disclosed herein may be implemented as a computer program that may be tangibly or intangibly embodied by a special purpose computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” may also include distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

A module, a device, a mechanism, a unit and or a subsystem may each comprise a machine or machines executable instructions (e.g. commands). A module may be embodied by a circuit or a controller programmed to cause the system to implement the method, process and/or operation as disclosed herein. For example, a module may be implemented as a hardware circuit comprising, e.g., custom very large-scale integration (VLSI) circuits or gate arrays, an Application-specific integrated circuit (ASIC), off-the-shelf semiconductors such as logic chips, transistors, and/or other discrete components. A module may also be implemented in programmable hardware devices such as field programmable gate arrays, programmable array logic, programmable logic devices and/or the like.

In the above disclosure, unless otherwise stated, terms such as “substantially”, “about”, approximately, etc., that specify a condition or relationship characterizing a feature or features of an embodiment of the invention, are to be understood to mean that the condition or characteristic is defined to within tolerances that are acceptable for operation of the embodiment for an application for which it is intended.

It is important to note that the methods/processes and/or systems/devices/subsystems/apparatuses etc., disclosed in the above Specification, are not to be limited strictly to flowcharts and/or diagrams provided in the Drawings. For example, a method may include additional or fewer processes or steps in comparison to what is described in the figures. In addition, embodiments of the method are not necessarily limited to the chronological order as illustrated and described herein.

It is noted that terms such as “processing”, “computing”, “calculating”, “determining”, “establishing”, “analyzing”, “checking”, “estimating”, “deriving”, “selecting”, “inferring”, identifying”, “detecting” and/or the like, may refer to operation(s) and/or process(es) of a computer, a computing platform, a computing system, or other electronic computing device(s), that manipulate and/or transform data represented as physical (e.g., electronic or optical signal) quantities within the computer's registers and/or memories into other data similarly represented as physical quantities within the computer's registers and/or memories or other information storage medium that may store instructions to perform operations and/or processes.

Terms used in the singular shall also include a plural scope, except where expressly otherwise stated or where the context otherwise requires.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made i.e. enabling all possible combinations of one or more of the specified options. Further, the use of the expression “and/or” may be used interchangeably with the expressions “at least one of the following”, “any one of the following” or “one or more of the following”, followed by a listing of the various options.

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

It is noted that the terms “in some embodiments”, “in certain embodiments”, “according to some embodiments”, “according to some embodiments of the invention”, “for example”, “e.g.”, “for instance” and “optionally” may herein be used interchangeably.

The number of elements shown in the Figures should by no means be construed as limiting and is for illustrative purposes only.

It is noted that the terms “operable to” can encompass the meaning of the term “modified or configured to”. In other words, a machine “operable to” perform a task can in some embodiments, embrace a mere capability (e.g., “modified”) to perform the function and, in some other embodiments, a machine that is actually made (e.g., “configured”) to perform the function.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

1. A liquid measuring system (LMS) comprising:
at least one light source;
at least one multi-region optical filter (MROF) comprising: at least one first filter region configured for a first type of optical filtering; and at least one second filter region, configured for a second type of optical filtering, different than the first type of optical filtering, wherein the MROF is designed such that its filter regions are located adjacent to one another in a manner that enables simultaneous different filtering of different spatial parts of incoming light beam;
a sample cell configured to contain a liquid sample therein, the sample cell being partially or fully transparent to allow light from the at least one light source to enter therein and light to exit therethrough;
an optical detection subsystem (ODS), comprising at least one optical detector for measuring optical properties of light emanating from the liquid sample, for measuring one or more characteristics of the liquid sample; and
an optical subsystem configured and positioned for:
directing at least one part of light emanating from the sample cell towards the at least one first filter region of the MROF, for measuring biomass concentration by measuring properties of fluorescence light irradiated from the liquid sample in the sample cell; and
directing at least one other part of light emanating from the sample cell towards the at least one second filter region of the MROF, for measuring turbidity level by measuring properties of scattered light irradiated from the liquid sample in the sample cell, thereby enabling simultaneous measuring of turbidity and biomass properties of the liquid sample,
wherein the optical subsystem comprises a combined-lens-array configured and positioned to form multiple images over the different MROF filter regions.

2. The LMS of claim 1, wherein the at least one first filter region comprises a bandpass or a long-pass filter region configured for transmission of light of a specific wavelength range or that exceed a specific wavelength threshold, and the at least one second filter region comprises a natural density (ND) filter region or a bandpass filter region.

3. (canceled)

4. (canceled)

5. (canceled)

6. The LMS of claim 1 further comprising:
(i) a first optical setup configured and positioned for directing light emanating from the light source towards the sample cell;
(ii) a second optical setup for directing light exiting the sample cell towards the MROF.

7. The LMS of claim 6, wherein the second optical setup comprises at least one of:
(i) an obstruction element positioned and configured to block a portion of the light exiting from the sample cell at a specific area around the main optical axis x;
(ii) a combined-lens-array comprising at least two focusing lenses parts a first focusing lens part and a second focusing lens part coupled to one another, for focusing at least one part of the light emanating from the sample cell towards the at least one spectral filter region of the MROF, and focusing at least one other part of the exiting light towards the at least one other spectral filter region of the MROF.

8. The LMS of claim 1, wherein the at least one optical detector of the ODS comprises a spectrometer and/or a pixelated optical detector.

9. The LMS of claim 8, wherein the pixelated optical detector comprises one of: at least one pixelated charged coupled device (CCD), an active pixelated sensor, an array of photodiodes, an array of photodetectors.

10. The LMS of claim 8, wherein the ODS further comprises one or more aperture elements located in proximity to an input surface of the at least one optical detector.

11. The LMS of claim 1, wherein the biomass comprises one or more types of: algae, microalgae or any other biological substance that can generate responsive fluorescence radiation.

12. The LMS of claim 1, wherein the MROF is located between the at least one light source and the sample cell, for selective spectral attenuation of the light emanating from the at least one light sources for improved measurement of the absorption spectrum of the liquid sample.

13. The LMS of claim 12 further comprising a mixing component located between the light source and the MROF.

14. The LMS of claim 12 further comprising a second mixing component, located between the MROF and the ODS or preferably between the MROF and the sample cell, for spectral spatial distribution unification.

15. The LMS of claim 12, further comprising at least one optical element configured and located to direct, collect and/or collimate light emanating from the sample cell to the ODS.

16. The LMS of claim 12, wherein one region of the MROF comprises a transparent silica substrate having separated regions thereof coated with a light absorbing, reflective or blocking coating material, for selective reduction of light from some spectral regions that may later stray in the ODS and adversely impact the measurement accuracy in other spectral regions.

17. The LMS of claim 1, wherein the MROF is segmented, having multiple segments of alternating filter region types.

18. The LMS of claim 1, wherein the at least one light source comprises at least one Xenon lamp or at least one light emitting diode (LED).

19. The LMS of claim 1, wherein the at least one light source is configured to output light within a wavelength spectral range having a wavelength peak of between 300-450 nanometer (nm), and/or having output power of between 10-3000 mW (microwatt).

20. The LMS of claim 1 comprising at least two MROFs at least one MROF being located between the at least one light source and the sample cell configured for selective spectral attenuation of incoming light and at least one additional MROF located between the sample cell and the ODS configured for simultaneous spectral measuring of scattered and fluorescence light emanating from the liquid sample at least for simultaneous turbidity level and biomass concentration measuring.

21. A method for simultaneous measuring of turbidity level and biomass concentration in a water sample, held in a sample cell, the method comprising, at least:
directing light emanating from at least one light source, through a sample cell holding therein a water sample;
directing at least one part of the light emanating from the sample cell towards the at least one first filter region of the MROF, for measuring biomass concentration by measuring properties of fluorescence light irradiated from the liquid sample in the sample cell; and
directing at least one other part of light emanating from the sample cell towards the at least one second filter region of the MROF, for measuring turbidity level by measuring properties of scattered light irradiated from the liquid sample in the sample cell, thereby enabling simultaneous measuring of turbidity and biomass properties of the liquid sample; and
detecting optical characteristics of the light exiting the MROF, using an optical detection subsystem, to simultaneously, measure at least turbidity level and biomass concentration,
wherein the directing of the light towards different regions of the MORF is done by using at least a combined-lens-array configured and positioned to form multiple images over the different MROF filter regions.

22. The method of claim 21, wherein the turbidity level is measured by detection of spectral properties of scattered light components transmitted via at least one of the at least two filter regions of the MROF, and the biomass concentration of quantity is measured by detection of properties of fluorescence light components transmitted via at least one other filter region of the MROF.

23. The method of claim 21, wherein at least one of the filter regions of the MROF comprises at least one natural density (ND) or at least one bandpass filter configured for improving scattered light measurements and at least one other filter region of the MROF comprises a bandpass or long-pass filter configured for improving fluorescence light measurements.

24. (canceled)

25. (canceled)
